(19) United States
(12) Patent Application Publication
(10) Pub. No.: US 2025/0147145 A1
(43) Pub. Date: May 8, 2025

(54) DEEP-SEA SOUND SOURCE LOCALIZATION METHOD, COMPUTER DEVICE, AND STORAGE MEDIUM

(71) Applicant: Institute of Acoustics, Chinese Academy of Sciences, Beijing (CN)

(72) Inventors: Jixing QIN, Beijing (CN); Yushen WU, Beijing (CN); Zhenglin LI, Beijing (CN); Haibin WANG, Beijing (CN); Shuanglin WU, Beijing (CN); Mengyuan WANG, Beijing (CN); Yiming GU, Beijing (CN)

(21) Appl. No.: 18/836,486

(22) PCT Filed: Oct. 14, 2022
(86) PCT No.: PCT/CN2022/125401

§ 371 Date: Aug. 7, 2024

(30) Foreign Application Priority Data
May 5, 2022 (CN) 202210480362.X

(51) Int. Cl. G01S 5/30

(52) U.S. Cl. CPC G01S 5/30; G01S 2205/04

(57) ABSTRACT

A deep-sea sound source localization method, a computer device and a storage medium. The method includes: deploying at least two underwater gliders in a designated sea area, so as to respectively record a broadband signal which is emitted by a broadband sound source (1); obtaining a waveform envelope of the signal, and then calculating a waveform envelope of a simulated signal (2); performing cross-correlation analysis on the two waveform envelopes (3); and determining an estimated value of a distance from the sound source, and finally obtaining an estimated position of the sound source by means of a geometrical relationship (3). By means of the method, deployment of a large-depth vertical receiving array is not required. The system has low complexity, and is easy to deploy and operate, which can be applied to a relatively large area. In addition, simple data analysis and calculation are performed without the need for manual parameter adjustment, and target localization can be achieved only by knowing an approximate azimuth of movement of a target. Underwater gliders have good maneuverability and can be deployed according to task requirements, thereby achieving target localization and tracking in a relatively large area.

### CROSS-REFERENCE TO RELATED APPLICATION

This application claims priority to Chinese patent application No. 202210480362.X, entitled “Deep-Sea Sound Source Localization Method, Computer Device, and Storage Medium” filed on May 5, 2022, which is incorporated herein by reference.

### TECHNICAL FIELD

The present invention relates to the field of hydroacoustic engineering, ocean engineering, and sonar technology, and in particular, relates to a deep-sea acoustic source localization method, a computer device, and a storage medium.

### BACKGROUND

A marine environment is complex and variable, leading to spatial and temporal variations generally in underwater acoustic field characteristics, which causes adverse effects on target detection and hydroacoustic communication and other activities. Conversely, sound field characteristics under specific conditions can also reflect information about underwater targets and the marine environment. Therefore, making full use of the ocean acoustic field characteristics can achieve localization of underwater sound sources. As a new type of underwater measurement platform, underwater gliders have the characteristics of low energy consumption, low noise, reusability and long work time, etc. They may be equipped with other instruments and equipment as needed so as to perform multi-glider collaborative observation, and have broad application prospects in precision marine environment and global marine security and environment observation. Therefore, an underwater glider may be equipped with an acoustic recording system to implement target identification and tracking.

Various means of sound source localization mainly include matched-field methods, multipath arrival structure based methods, sound field interference structure based methods, etc. For a position estimation method based on a multi-path arrival structure, see reference [1] (“Particle filter for multipath time delay tracking from correlation functions in deep water”, published in July 2018 in J. Acoust. Soc. Am., Volume 144, starting on page 397). The method analyzes a relationship between time delays of direct and surface reflected waves over time, and extracts a time delay difference through an autocorrelation function to achieve broadband moving target localization using a single hydrophone. It has the disadvantages that parameters need to be adjusted manually, calculation is complicated, a bandwidth of a target does not meet the requirement of delay resolution, and the target needs to move along a radial direction of the hydrophone. In a position estimation method based on an acoustic field interference structure, there is an obvious multipath arrival structure in a signal, and multipath delays correspond to an interference period in a frequency domain. A target may be localized by using the periodicity of interference fringes. For this method, see reference [2] (“Source localization by matching sound intensity with a vertical array in the deep ocean”, published in December 2019 in J. Acoust. Soc. Am., Volume 146, starting on page 477). It utilizes a signal sound intensity frequency-distance interference structure with a large-depth vertical array to localize an underwater sound source within 10-30 km of a direct sound zone of deep sea. It has the disadvantages that deployment of a large-depth vertical receiving array is required, system complexity is high, and data covering the large-depth vertical receiving array is required, and the sea depth needs to meet a requirement.

### SUMMARY OF THE INVENTION

An object of the present invention to overcome the shortcomings that a method based on an acoustic field interference structure requires deployment of a vertical receiving array system with high complexity and poor maneuverability, and a method based on a multi-path arrival structure requires manual adjustment of parameters and complex calculation.

To achieve the above object, the present invention proposes a deep-sea sound source localization method, a computer device, and a storage medium. The method includes: deploying at least two underwater gliders in a designated sea area, so as to respectively record a broadband signal which is emitted by a broadband sound source, and obtaining an estimated position of the sound source by signal analysis and calculation.

As an improvement of the above method, the method specifically includes:
step 1: deploying at least two underwater gliders in a designated sea area, so as to respectively record a broadband signal which is emitted by a broadband sound source;
step 2: calculating a waveform envelope of the signal recorded by each underwater glider, and calculating a waveform envelope of a simulated signal;
step 3: performing cross-correlation analysis on the waveform envelope of the signal recorded by each underwater glider, and the waveform envelope of the simulated signal; and
step 4: obtaining a position of the sound source by means of a geometrical relationship.

As an improvement of the above method, two underwater gliders are deployed in the designated sea area.

As an improvement of the above method, a system of the underwater gliders is at a distance of less than 100 km from the sound source, a depth of which is known, and a frequency of which is greater than or equal to 200 Hz.

As an improvement of the above method, step 2 is specifically: recording the broadband signal emitted by the broadband sound source by using the at least two underwater gliders, respectively, obtaining a waveform of the signal recorded by each underwater glider, respectively, by Hilbert transform; obtaining a signal at each of different distances by calculating parameters of a static oceanic environment, and obtaining a waveform envelope of the signal obtained by parameter calculation, by Hilbert transform, the step specifically including:
at an observation time t₀<t<t₀+Δt, recorded by each underwater glider, the signal of the broadband sound source respectively as s(r,z,t), where r is a distance from the underwater glider to the sound source, and z is a depth where the underwater glider is located at a signal recording time;
obtaining the waveform envelope [symbol] (r,z,t) of the signal recorded by the underwater glider, by Hilbert transform:

$${s}_{1}^{\%} ( r , z , t ) = \vert {s}_{1} ( r , z , t ) + j * H ( {s}_{1} ( r , z , t ) ) \vert$$

where H(⋅) is Hilbert transform, |⋅| is an absolute value operator, and j is \sqrt{−1};
obtaining a channel transfer function g(r′,z′,ω) for different distance depths by simulating calculation using a range-dependent acoustic model-parabolic equation RAM-PE and known SSP data, with a frequency spectrum S(ω), so a signal s_{cal}(r′,z′,t) at a receiving point is expressed as:

$${s}_{cal} ( {r}^{′} , {z}^{′} , t ) = \frac{1}{2 π} {\int }_{- ∞}^{∞} S ( ω ) g ( {r}^{′} , {z}^{′} , ω ) {e}^{- j ω t} d ω$$

where r′ is a search distance, z′ is a search depth, and ω is a frequency; and
obtaining the waveform envelope [symbol] (r′,z′,t) of the simulated signal by Hilbert transform:

$${s}_{cal}^{\%} ( {r}^{′} , {z}^{′} , t ) = \vert {s}_{cal} ( {r}^{′} , {z}^{′} , t ) + j * H ( {s}_{cal} ( {r}^{′} , {z}^{′} , t ) ) \vert$$

where H(⋅) is Hilbert transform, |⋅| is an absolute value operator, and j is \sqrt{−1}.

As an improvement of the above method, step 3 is specifically: performing cross-correlation analysis on the waveform envelope of the signal recorded by each underwater glider, and the waveform envelope of the simulated signal obtained by parameter calculation, calculating a distance between a target and each underwater glider, and using a position corresponding to a point of a maximum value of a cross-correlation function to indicate an estimated value of a distance from the sound source, the step specifically including:
performing cross-correlation analysis on the waveform envelope [symbol] (r,z,t) of the signal recorded by one underwater glider and the waveform envelope [symbol] (r,z,t) of the signal obtained by parameter calculation:

$${ρ}_{1} ( r , {r}^{′} ) = {max}_{τ} \frac{{\int }_{- ∞}^{+ ∞} {s}_{1}^{\%} ( r , z , t ) {s}_{cal}^{\%} ( {r}^{′} , {z}^{′} , t + τ ) dt}{\sqrt{{\int }_{- ∞}^{+ ∞} {s}_{1}^{\%2} ( r , z , t ) dt {\int }_{- ∞}^{+ ∞} {s}_{cal}^{\%2} ( {r}^{′} , {z}^{′} , t ) dt}}$$

where r is a true distance, r′ is a search distance, z′ is a search depth, and τ is a time delay, wherein a cross-correlation coefficient ρ₂(r,r′) between numerical results for different distances and an experimental result is obtained by using the search distance r′; using a distance corresponding to a maximum value of η₂(r,r′) to indicate an estimated value R of a horizontal distance between the sound source and the glider; and in the same way, calculating an estimated distance between the sound source and other underwater glider(s).

As an improvement of the above method, step 4 is specifically: obtaining a position of the sound source by a geometrical relationship using an estimated value of a distance of each glider from the sound source; and
using each underwater glider as a circle center, and a distance estimated value R as a radius to make a circle, drawing a plurality of circles respectively in this way, and obtaining an estimated position of the sound source only when the circles have a point of intersection.

The present invention also provides a computer device, including a memory, a processor, and a computer program stored in the memory and operable by the processor, wherein when executing the computer program, the processor implements the method of any one of claims 5 to 7.

The present invention also provides a computer readable storage medium, configured to store a computer program, wherein the computer program, when executed by a processor, causes the processor to implement the method of any one of claims 5 to 7.

Compared with the prior art, the present invention has the following advantages:

The method of the present invention can localize a deep-sea sound source by using a system of a plurality of underwater glider. Compared with a traditional method based on a vertical array, it does not require deployment of a large-depth vertical receiving array, and the system has low complexity, is easy to deploy and operate, and can be applied to a relatively large area. Simple data analysis and calculation are performed without the need for manual parameter adjustment, and target localization can be achieved only by knowing an approximate azimuth of movement of a target. Using a work mode of a plurality of underwater gliders collaborating in a network, a ranging error brought by a single glider is eliminated, and two-dimensional localization of an underwater target is achieved. Underwater gliders have good maneuverability and can be deployed according to task requirements, thereby achieving target localization and tracking in a relatively large area.

### BRIEF DESCRIPTION OF THE DRAWINGS

FIG. 1 shows a flow diagram of a deep-sea sound source localization method;

FIG. 2 shows a schematic diagram of relative positions of a sound source and underwater gliders;

FIG. 3(a) shows changes in a waveform envelope of a signal recorded by a first underwater glider and a waveform envelope of a simulated signal over time in embodiments;

FIG. 3(b) shows changes in a waveform envelope of a signal recorded by a second underwater glider and a waveform envelope of a simulated signal over time in embodiments;

FIG. 4(a) shows a cross-correlation function between a waveform envelope of a signal recorded by a first underwater glider and a waveform envelope of a simulated signal in embodiments;

FIG. 4(b) shows a cross-correlation function between a waveform envelope of a signal recorded by a second underwater glider and a waveform envelope of a simulated signal in embodiments;

FIG. 5 shows a schematic diagram of target localization in the embodiments;

FIG. 6(a) shows a position estimation result of a sound source in a sea experiment in embodiments; and

FIG. 6(b) shows a position estimation result of a sound source in a sea experiment in embodiments.

### DETAILED DESCRIPTION

In order to avoid the drawbacks of the prior art, the present invention proposes a deep-sea sound source localization method, a computer device, and a storage medium, to solve the problems in a sound source localization method in a deep-sea environment that a complex vertical receiving array needs to be deployed or calculation is complex, etc.

The technical solutions of the present invention will be described in detail below in conjunction with the accompanying drawings.

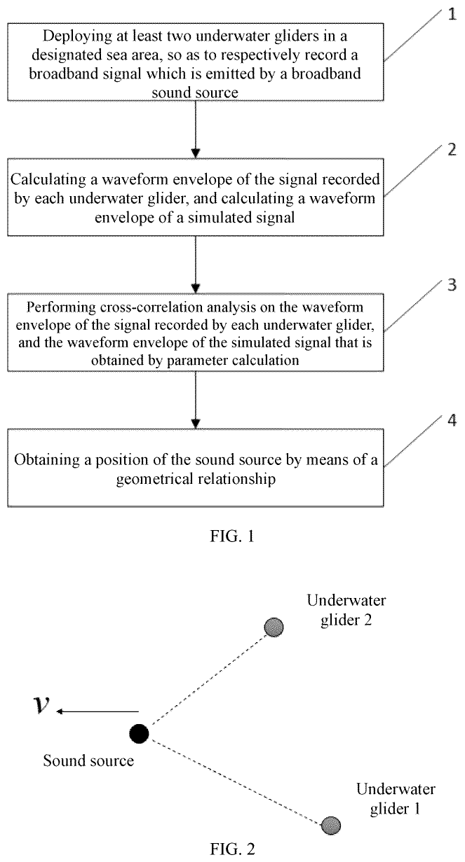

As shown in FIG. 1, the present invention proposes a deep-sea sound source localization method, including: deploying at least two underwater gliders in a designated sea area, so as to respectively record a broadband signal which is emitted by a broadband sound source; obtaining a waveform envelope of the signal, and then calculating a waveform envelope of a simulated signal; performing cross-correlation analysis on the two waveform envelopes; and determining an estimated value of a distance from the sound source, and finally obtaining an estimated position of the sound source by means of a geometrical relationship.

Step 1: deploying at least two underwater gliders in a designated sea area, so as to respectively record a broadband signal which is emitted by a broadband sound source.

This embodiment uses two underwater gliders as an example. At first, two underwater gliders are deployed in a designated sea area, and a broadband signal emitted by a broadband sound source is recorded respectively by using the two underwater gliders. A system of the underwater gliders is at a distance of less than 100 km from the sound source, a depth of which is known, and a frequency of which is greater than or equal to 200 Hz.

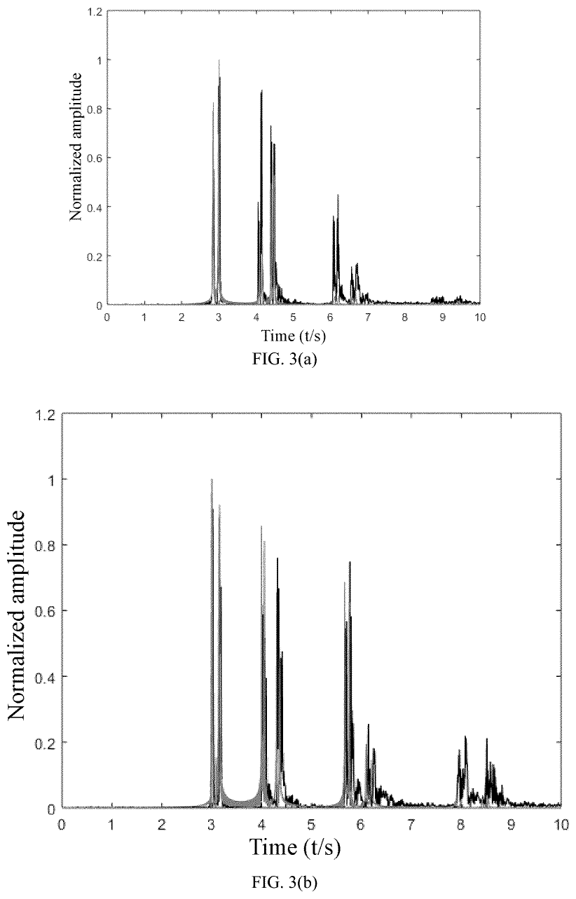

The two underwater gliders are deployed in the designated sea area, and the sound source gradually moves away from the underwater gliders. A horizontal distance between the sound source and each underwater glider is 0 km-100 km, and a receiving depth of each underwater glider is 0-1000 m. The underwater gliders move along a predetermined trajectory, and ascend and descend while receiving and recording the signal from the sound source, referring to FIG. 2. In this embodiment, the sound source is at a distance of 49.2 km and 39.8 km from the two underwater gliders, respectively. The sound source is a broadband explosive sound source with a depth of 200 m, and an explosive sound source is deployed every 6 minutes.

Step 2: calculating a waveform envelope of the signal recorded by each underwater glider, and calculating a waveform envelope of a simulated signal.

In this embodiment, at an observation time t₀<t<t₀+Δt, the signal of the broadband sound source is recorded by each of the two underwater gliders respectively as s(r,z,t), where r is a distance from the underwater glider to the sound source, and z is a depth where the underwater glider is located at a signal recording time; and the waveform envelope [symbol] (r,z,t) of the signal recorded by the underwater glider is obtained by Hilbert transform on the received signal:

$${s}^{\%} ( r , z , t ) = \vert s ( r , z , t ) + j * H ( s ( r , z , t ) ) \vert$$

where H(⋅) is Hilbert transform, |⋅| is an absolute value operator, and j is \sqrt{−1}.

Knowing the depth of the sound source, a channel transfer function g(r′,z′,ω) for different distance depths is obtained by simulation calculation using a range-dependent acoustic model-parabolic equation RAM-PE and known SSP data, wherein the transfer function reflects propagation characteristics between the sound source and a receiver, with a frequency spectrum S(ω), so a signal s_{cal}(r′,z′,t) at a receiving point may be expressed as:

$${s}_{cal} ( {r}^{′} , {z}^{′} , t ) = \frac{1}{2 π} {\int }_{- ∞}^{∞} S ( ω ) g ( {r}^{′} , {z}^{′} , ω ) {e}^{- j ω t} d ω$$

where r′ is a search distance, z′ is a search depth, and ω is a frequency. In this embodiment, the frequency ω of the sound source is selected with a center frequency of 300 Hz, a bandwidth of 100 Hz, and a frequency interval of 0.1 Hz, corresponding to a time window length of 10 s, the search distance r′ is 0-100 km, and the search depth z′ is 0-1000 m.

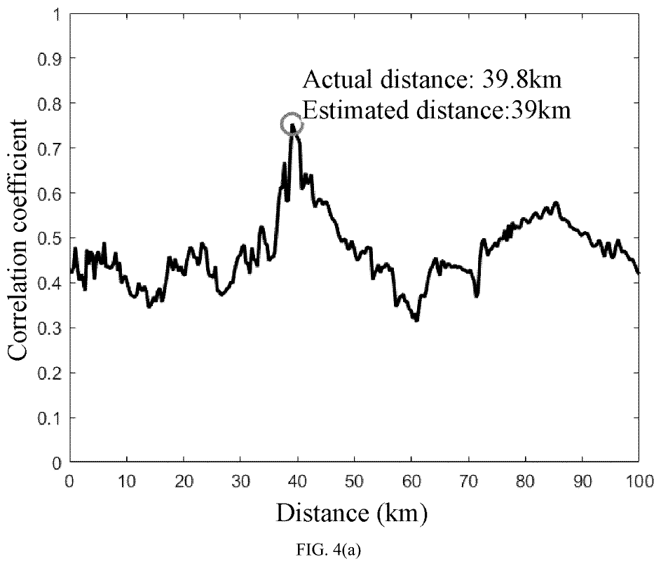

The waveform envelope [symbol] (r′, z′,t) of the simulated signal is obtained by Hilbert transform:

$${\tilde{s}}_{cal} ( {r}^{′} , {z}^{′} , t ) = \vert {s}_{cal} ( {r}^{′} , {z}^{′} , t ) + j * H ( {s}_{cal} ( {r}^{′} , {z}^{′} , t ) ) \vert$$

where H(⋅) is Hilbert transform, |⋅| is an absolute value operator, and j is \sqrt{−1}. In this way, the waveform envelope of the signal recorded by each of the underwater gliders at different distances and the waveform envelope of the signal obtained by parameter calculation are obtained respectively, as shown in FIG. 3.

Step 3: performing cross-correlation analysis on the waveform envelope of the signal recorded by each underwater glider, and the waveform envelope of the simulated signal obtained by parameter calculation.

Cross-correlation analysis is performed on the waveform envelope of the signal recorded by each underwater glider, and the waveform envelope of the simulated signal obtained by parameter calculation. A distance between a target and the underwater glider is calculated. A position corresponding to a point of a maximum value of a cross-correlation function is used to indicate an estimated value of a distance from the sound source.

In this embodiment, signals at receiving depths in the range of 50-850 m are selected for analysis. Cross-correlation analysis is performed on the waveform envelope of the signal recorded by each underwater glider, and the waveform envelope of the simulated signal obtained by parameter calculation. A distance between a target and the underwater glider is calculated. A position corresponding to a point of a maximum value of a cross-correlation function is used to indicate an estimated value of a distance from the sound source.

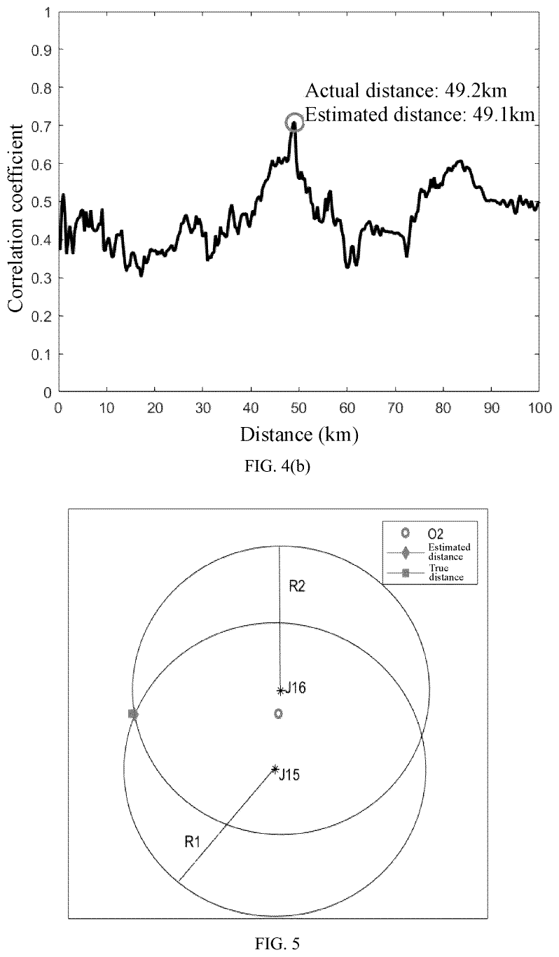

Knowing a signal receiving depth of the underwater glider, cross-correlation analysis is performed on the waveform envelope [symbol] (r,z,t) of the signal recorded by the underwater glider and the waveform envelope [symbol] (r′,z′,t) of the simulated signal obtained by parameter calculation:

$${ρ}_{1} ( r , {r}^{′} ) = {max}_{τ} \frac{{\int }_{- ∞}^{+ ∞} {s}^{\%} ( r , z , t ) {s}_{cal}^{\%} ( {r}^{′} , {z}^{′} , t + τ ) dt}{\sqrt{{\int }_{- ∞}^{+ ∞} {s}^{\%2} ( r , z , t ) dt {\int }_{- ∞}^{+ ∞} {s}_{cal}^{\%2} ( {r}^{′} , {z}^{′} , t ) dt}}$$

where r is a true distance, r′ is a search distance, z′ is a search depth, and τ is a time delay. A cross-correlation coefficient ρ(r,r′) between numerical results for different distances and an experimental result is obtained by using the search distance r′, and a distance corresponding to a maximum value of ρ(r,r′) is used to indicate an estimated value R of a horizontal distance between the sound source and the underwater glider. As shown in FIGS. 4(a) and 4(b), estimated distances R1 and R2 between the sound source and the two underwater gliders are 49.1 km and 39 km, respectively.

Step 4: obtaining a position of the sound source by means of a geometrical relationship.

This embodiment uses the estimated values of the distances of the two underwater gliders from the sound source to obtain the position of the sound source by means of a geometrical relationship.

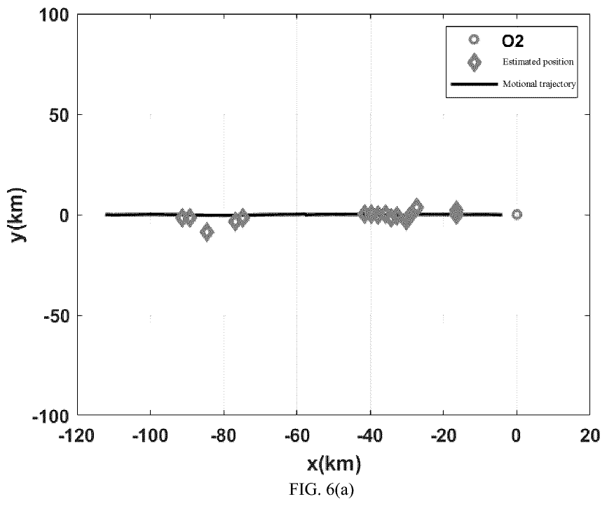

Knowing an approximate azimuth of the target's movement, the position of the sound source is obtained by means of a geometrical relationship using the estimated values of the distances of the two underwater gliders from the sound source; and circles are drawn with the first and second underwater gliders as circle centers, respectively. The distance estimated values R1 and R2 as radii, respectively, and an estimated position of the sound source can be obtained only when the two circles have a point of intersection. As shown in FIG. 5, O2 is a fixed reference point for measuring distances, J15 and J16 represent positions of the two underwater gliders.

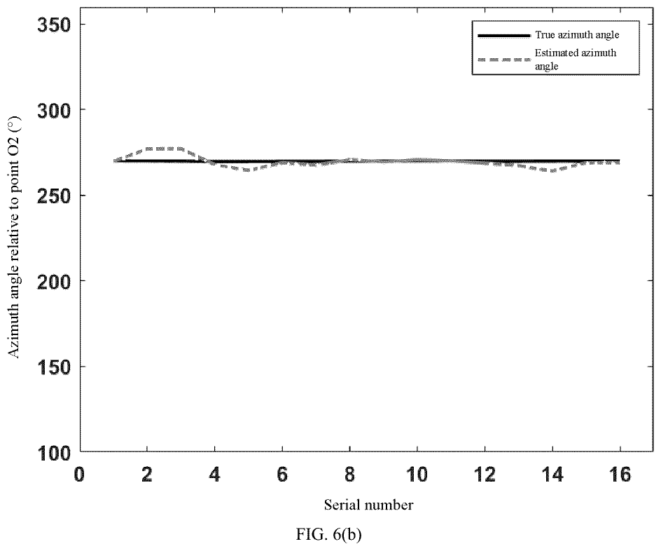

Received data is processed using the above steps, and estimated target positions and angles of arrival are shown in FIG. 6. In FIG. 6(a), a solid line is a motion trajectory of the sound source, and diamond points are experimentally estimated positions, and in FIG. 6(a), a solid line represents the target's true azimuth (270°), and a dashed line represents experimentally estimated azimuth angles, wherein O2 is a fixed reference point for measuring distances. It can be seen that the estimated positions of the sound source are distributed around the motion trajectory, a root-mean-square error of distance estimates is 3 km, and a relative error is less than 4%; the estimated target azimuths are consistent with the actual azimuth, and a root-mean-square-error of azimuth estimates is 3.3°. Validation of measured data shows that the method of the present invention can effectively estimate positions of deep-sea sound sources.

The present invention requires only two underwater gliders to localize a sound source target in a designated sea area. The system has low complexity, and is easy to deploy and operate, and a plurality of underwater gliders collaborating in a network may cover a relatively large area.

The present invention may also provide a computer device, including at least one processor, a memory, at least one network interface, and a user interface. Components of the device are coupled together via a bus system. It may be understood that the bus system is configured to implement connection and communication between these components. The bus system includes a power bus, a control bus, and a status signal bus in addition to a data bus.

The user interface may include a display, a keyboard, or a clicking device (e.g., a mouse, a track ball, a touch pad, or a touch screen).

It may be understood that the memory in embodiments of the present disclosure may be a volatile memory or a non-volatile memory, or may include both a volatile memory and a non-volatile memory. The memory described herein is intended to include, but is not limited to, these and any other suitable types of memory.

In some implementations, the memory stores the following elements, executable modules or data structures, or a subset thereof, or an extended set thereof: an operating system and an application.

The operating system includes various system programs, for implementing various basic services and performing hardware-based tasks. The application includes various applications, for implementing various application services. A program for implementing the method of embodiments of the present disclosure may be included in the application.

In the above embodiments, furthermore, by calling a program or instructions stored in the memory, which may specifically be a program or instructions stored in the application, the processor is configured to:
execute the steps of the method of Embodiment 1.

The method of Embodiment 1 may be applied in the processor or implemented by the processor. The processor may be an integrated circuit chip with signal processing capability. During implementation, the steps of the above-mentioned method may be accomplished by an integrated logic circuit in the form of hardware or instructions in the form of software in the processor. The above-mentioned processor may be a general-purpose processor or other programmable logic device. The various methods, steps and logical block diagrams disclosed in Embodiment 1 may be implemented or executed. The general-purpose processor may be a microprocessor, or the processor may also be any conventional processor or the like.

It may be understood that these embodiments described in the present invention may be implemented with hardware, software, firmware, middleware, microcode, or a combination thereof.

For software implementation, the technology of the present invention may be implemented by executing functional modules (e.g. processes, and functions) of the present invention. Software code may be stored in the memory and executed by the processor. The memory may be implemented in the processor or outside the processor.

The present invention also provides a non-volatile storage medium configured to store a computer program. When the computer program is executed by the processor, the steps in the above method embodiment may be implemented.

Finally, it should be noted that the above embodiments are only used for describing instead of limiting the technical solutions of the present invention. Although the present invention is described in detail with reference to the embodiments, persons of ordinary skill in the art should understand that modifications or equivalent substitutions of the technical solutions of the present invention should be encompassed within the scope of the claims of the present invention so long as they do not depart from the spirit and scope of the technical solutions of the present invention.

1. A deep-sea sound source localization method, comprising: deploying at least two underwater gliders in a designated sea area, so as to respectively record a broadband signal which is emitted by a broadband sound source, and obtaining an estimated position of the sound source by signal analysis and calculation.

2. The deep-sea sound source localization method according to claim 1, specifically comprising:
step 1: deploying at least two underwater gliders in a designated sea area, so as to respectively record a broadband signal which is emitted by a broadband sound source;
step 2: calculating a waveform envelope of the signal recorded by each underwater glider, and calculating a waveform envelope of a simulated signal;
step 3: performing cross-correlation analysis on the waveform envelope of the signal recorded by each underwater glider, and the waveform envelope of the simulated signal that is obtained by parameter calculation; and
step 4: obtaining a position of the sound source by means of a geometrical relationship.

3. The deep-sea sound source localization method according to claim 1, wherein two underwater gliders are deployed in the designated sea area.

4. The deep-sea sound source localization method using underwater gliders according to claim 2, wherein a system of the underwater gliders is at a distance of less than 100 km from the sound source, a depth of which is known, and a frequency of which is greater than or equal to 200 Hz.

5. The deep-sea sound source localization method according to claim 2, wherein step 2 is specifically recording the broadband signal emitted by the broadband sound source by using the at least two underwater gliders, respectively, obtaining a waveform of the signal recorded by each underwater glider, respectively, by Hilbert transform; obtaining a signal at each of different distances by calculating parameters of a static oceanic environment, and obtaining a waveform envelope of the signal obtained by parameter calculation, by Hilbert transform, the step specifically comprising:
at an observation time t₀<t<t₀+Δt, recorded by each underwater glider, respectively, the signal s(r,z,t) of the broadband sound source, where r is a distance from the underwater glider to the sound source, and z is a depth where the underwater glider is located at a signal recording time;
obtaining the waveform envelope [symbol] (r,z,t) of the signal recorded by the underwater glider, by Hilbert transform:
$${s}_{1}^{\%} ( r , z , t ) = \vert {s}_{1} ( r , z , t ) + j * H ( {s}_{1} ( r , z , t ) ) \vert$$
where H(⋅) is Hilbert transform, |⋅| is an absolute value operator, and j is \sqrt{−1};
obtaining a channel transfer function g(r′,z′,ω) for different distance depths by simulating calculation using a range-dependent acoustic model-parabolic equation RAM-PE and known SSP data, with a frequency spectrum S(ω), so a signal s_{cal}(r′,z′,t) at a receiving point is expressed as:
$${s}_{cal} ( {r}^{′} , {z}^{′} , t ) = \frac{1}{2 π} {\int }_{- ∞}^{∞} S ( ω ) g ( {r}^{′} , {z}^{′} , ω ) {e}^{- j ω t} d ω$$
where r′ is a search distance, z′ is a search depth, and ω is a frequency; and
obtaining the waveform envelope [symbol] (r′,z′,t) of the simulated signal by Hilbert transform:
$${s}_{cal}^{\%} ( {r}^{′} , {z}^{′} , t ) = \vert {s}_{cal} ( {r}^{′} , {z}^{′} , t ) + j * H ( {s}_{cal} ( {r}^{′} , {z}^{′} , t ) ) \vert$$
where H(⋅) is Hilbert transform, |⋅| is an absolute value operator, and j is \sqrt{−1}.

6. The deep-sea sound source localization method according to claim 2, wherein step 3 is specifically: performing cross-correlation analysis on the waveform envelope of the signal recorded by each underwater glider, and the waveform envelope of the signal obtained by parameter calculation, calculating a distance between a target sound source and each underwater glider, and using a position corresponding to a point of a maximum value of a cross-correlation function to indicate an estimated value of a distance from the sound source, the step specifically comprising:
performing cross-correlation analysis on the waveform envelope [symbol] (r,z,t) of the signal recorded by one underwater glider and the waveform envelope [symbol] (r,z,t) of the signal obtained by parameter calculation:
$${ρ}_{1} ( r , {r}^{′} ) = {max}_{τ} \frac{{\int }_{- ∞}^{+ ∞} {s}_{1}^{\%} ( r , z , t ) {s}_{cal}^{\%} ( {r}^{′} , {z}^{′} , t + τ ) dt}{\sqrt{{\int }_{- ∞}^{+ ∞} {s}_{1}^{\%2} ( r , z , t ) dt {\int }_{- ∞}^{+ ∞} {s}_{cal}^{\%2} ( {r}^{′} , {z}^{′} , t ) dt}}$$
where r is a true distance, r′ is a search distance, z′ is a search depth, and τ is a time delay, wherein a cross-correlation coefficient ρ₂(r,r′) between numerical results for different distances and an experimental result is obtained by using the search distance r′; using a distance corresponding to a maximum value of ρ₂(r,r′) to indicate an estimated value R of a horizontal distance between the sound source and the glider; and in the same way, calculating an estimated distance between the sound source and other underwater glider(s).

7. The deep-sea sound source localization method according to claim 2, wherein step 4 is specifically: obtaining a position of the sound source by a geometrical relationship using an estimated value of a distance of each glider from the sound source; and
using each underwater glider as a circle center, and a distance estimated value R as a radius to make a circle, drawing a plurality of circles respectively in this way, and obtaining an estimated position of the sound source only when the circles have a point of intersection.

8. A computer device, comprising a memory, a processor, and a computer program stored in the memory and operable by the processor, wherein when executing the computer program, the processor implements the method of claim 5.

9. (canceled)

10. A computer device, comprising a memory, a processor, and a computer program stored in the memory and operable by the processor, wherein when executing the computer program, the processor implements the method of claim 6.

11. A computer device, comprising a memory, a processor, and a computer program stored in the memory and operable by the processor, wherein when executing the computer program, the processor implements the method of claim 7.

12. A computer readable storage medium, configured to store a computer program, wherein the computer program, when executed by a processor, causes the processor to implement the method of claim 5.

13. A computer readable storage medium, configured to store a computer program, wherein the computer program, when executed by a processor, causes the processor to implement the method of claim 6.

14. A computer readable storage medium, configured to store a computer program, wherein the computer program, when executed by a processor, causes the processor to implement the method of claim 7.
